(19) United States
(12) Patent Application Publication
(10) Pub. No.: US 2016/0309678 A1
(43) Pub. Date: Oct. 27, 2016

(54) Nestable Pet Bed

(71) Applicant: Jill Garnet, Kasilof, AK (US)

(72) Inventor: Jill Garnet, Kasilof, AK (US)

(21) Appl. No.: 15/132,181

(22) Filed: Apr. 18, 2016

Related U.S. Application Data
(60) Provisional application No. 62/149,387, filed on Apr. 17, 2015.

(51) Int. Cl. A01K 1/035; A47C 27/00; A47C 27/14; A47C 27/15; A47C 31/10

(52) U.S. Cl. CPC A01K 1/0353; A47C 27/15; A47C 31/105; A47C 27/14; A47C 27/005; A47C 27/003

(57) ABSTRACT

A cushion support product comprising a cushion body with a cover defining its overall shape, the cover also defining at least two distinct vertically stacked zones encased within the cover, the lower zones, single or multiple, are filled with a resilient material, the uppermost zone is filled with resilient bulky soft pliable material, that is pieced into parts, and is loosely filled allowing space for shifting of the material within the zone, providing a nesting experience and a place of rest for the occupant.

### FIELD OF THE INVENTION

The present invention involves a cushion support product which is ideally suited for use as a pet bed and, more particularly but without limitation, to a domestic household animal bed.

### BACKGROUND OF THE INVENTION

Pet beds are popular in households for a variety of domestic animals. They provide a place for the animal to rest. Dogs in particular exhibit a behavior I will name a “nesting response” when readying to lay down. This nesting response occurs on dirt, flush upholstered furniture and on conventional pet bedding. This nesting response is a repeated pawing, nuzzling or circling by the dog prior to laying down. However, on upholstered furniture or conventional pet bedding, the pillow-like or cushion construction, is inflexible and lacking malleability. This rigid nature does not allow the animal to create it's own hollow and fulfill the “need to nest.”

Many sources relate this behavior as instinctual and hereditary in origin. According to the online source, the nest, “Scratching at the bed is instinctual; its what your dogs' wild kin have done for ages to soften the ground.” In addition to the instinct of den building experts believe this behavior is also a matter of comfort seeking by the dog. Vet Street online blog claims, circling before laying is an ancestral expression, “dog's ancestors had to sleep outside, in the elements, without much warmth or safety. Walking around a spot was a way to stamp down grass, leaves or snow and create a soft surface—something akin to carving out a nest.” The nest, further states “Your dog is behaving as he would while gathering moss or leaves to make a relatively comfy bed outside.” A feeling of comfort and safety may go hand in hand, “after she circles, does your dog scratch at the bedding or carpeting before curling up? Just like circling, the digging action is probably an ancestral behavior related to staying safe and comfortable.” Dogs are territorial and like to claim what is theirs. House trained dogs will refrain from marking with urine and use their paws instead. The nest, goes on to explain, “Dogs have sweat glands in their paws, which leave a scent on bedding when they scratch at it.”

Hence, in the interest of making the dogs feel empowered and able to satisfy these ingrained hereditary behaviors, there is a need for pet bedding that will maintain a dense base, providing firm support and also a transformative malleable top, which would physically respond to these nuzzling, pawing or circling actions. The invention which will follow in its completeness was prototype tested by 32 pets in 5 household's. During the testing phase, it was found that the nestable pet bed attracted other domestic animals and also adults and children. Therefore, although the idea was born to satisfy a dog's “need to nest,” the nestable pet bed serves a broader population in its fruition, function and actual application. Therefore broadly stated, this invention is a cushion support product intended for resting while sleeping or awake by a variety of species.

### BRIEF SUMMARY OF THE INVENTION

In one embodiment of the invention a nestable pet bed, a cushion support product is provided comprising, an outer woven fabric cover which holds two inserts. The outer woven fabric cover creates two inner zones and is designed to keep each insert within its intended zone. The zones are stacked vertically with an upper zone and a lower zone. The two inserts are independent and not similar in their function, design, shape or stuffing materials. The top pouch insert is designated to the upper zone and the base insert is designated to the lower zone.

The top pouch insert is encased in woven fabric and in the present embodiment contains stuffing material. The stuffing material of choice in our present embodiment is shredded polyurethane foam, thumbnail sized chunks. However, any material that could be pieced into parts while remaining soft and resilient would work. The stuffing material utilized should enhance the comfort of the nestable pet bed and must also be shiftable by the animal by way of nuzzling, pawing or circling. The woven fabric encasement of the top pouch insert, in the present embodiment, is the exact same size and dimension of the base insert. The shape of the top pouch insert is transformative due to the loose chunked stuffing material. The chunked pieces do not entirely fill the woven fabric encasement and therefore the top pouch insert can take on a variety of shapes contained within its upper zone of the outer woven fabric cover.

The base insert is encased in woven fabric and in the present embodiment contains stuffing material. The stuffing material of choice in the present embodiment is polyester fiber. Polyester fiber is widely used in the making of cushions, pillows and pet bedding. There exist a multitude of fiber varieties, in the present embodiment a siliconized variant is utilized. However, any material that could be densely packed inside the encasement providing a uniform shape with resilience, firm support and also comfort would work. The woven fabric encasement of the base insert in the present embodiment is the exact same size and dimension of the top pouch insert. The densely packed stuffing material in the base insert keeps it a uniform shape. Additionally, in the present embodiment, a baffle is sewn in the center region of the base insert. The baffle technique is utilized in the industry to keep the densely packed fiber from shifting, helping the object remain a uniform shape, as governed by its woven fabric encasement.

The outer woven fabric cover, provides an upper and lower zone in the present embodiment. The upper zone is the area which would be closest to the resting animal. Within the constraint of the outer woven fabric cover the top pouch insert transforms its shape in reaction to nuzzling, pawing or circling actions. This creates a supple hollow for the animal. Even without nuzzling, pawing or circling the shear weight of the animal on top of the nestable pet bed will create a depression mimicking a nest. The lower zone holding the base insert is underneath the hollow and provides a firm and comfortable support preventing the animal from sinking to the hard floor, for instance. With each use the shape of the nestable pet bed will change within the constraint of the outer woven fabric cover. In the present embodiment, the distribution of the weight of the animal is shared by both upper and lower zones.

### BRIEF DESCRIPTION OF THE SEVERAL VIEWS OF THE DRAWINGS

FIG. 1 is a view of a dog resting on a nestable pet bed.

FIG. 1b is a 3 view of a nestable pet bed in the complete embodiment of the present invention, as shown from the top.

FIG. 1c is an elevation view of a nestable pet bed in an embodiment of the invention.

FIG. 2 is an elevation view of a the top pouch insert in an embodiment of the invention.

FIG. 2b is a cross section view of FIG. 2 showing the chunked material inside the top pouch insert in an embodiment of the invention.

FIG. 3 is an offset plan/elevation view of the base insert in an embodiment of the invention.

FIG. 4 is a stacked view of FIG. 1c, FIG. 2 and FIG. 3 illustrating the way the components come together to make FIG. 2 in an embodiment of the invention.

### DETAILED DESCRIPTION OF THE INVENTION

At present I believe that this embodiment operates most efficiently, but the other embodiments are also satisfactory. It is expressly understood, that the drawings are for illustrative description only and are not intended as definitions of the limits of the invention. Those skilled in the art will appreciate the conception upon which this disclosure is based may readily be utilized as a basis for other structures. It is therefore important, that claims be regarded as including such equivalent constructions insofar as they do not depart from the spirit and scope of the present invention.

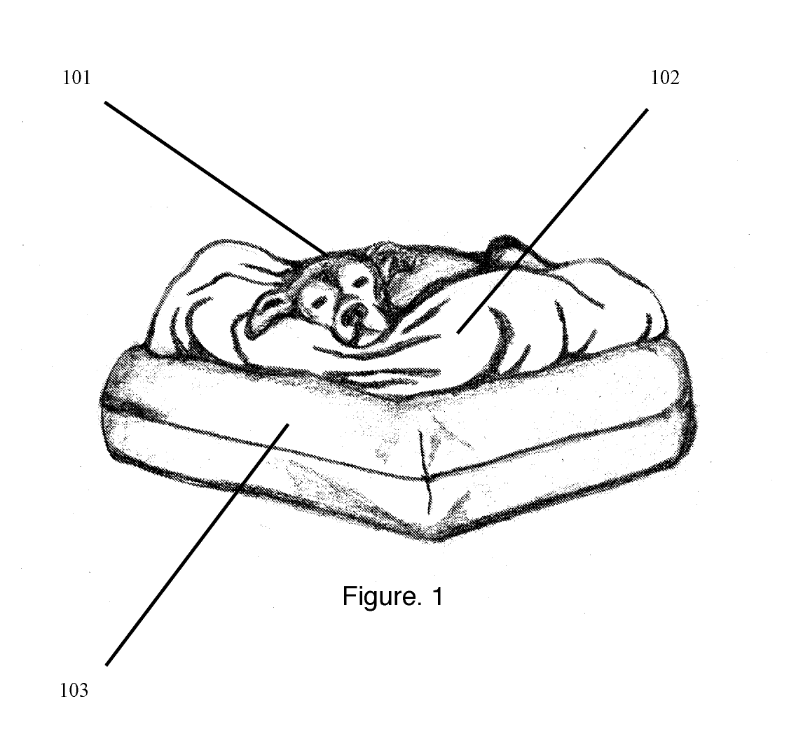

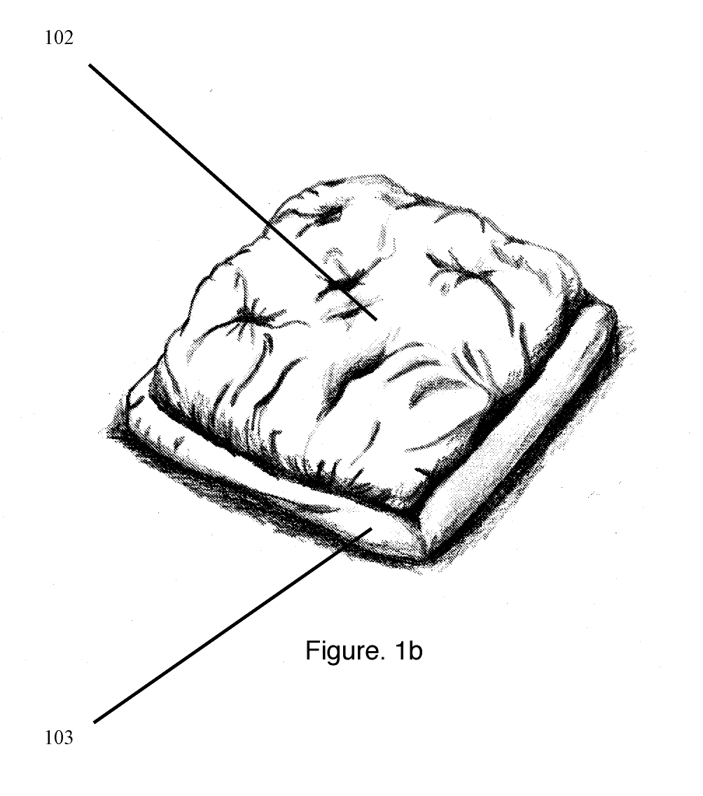

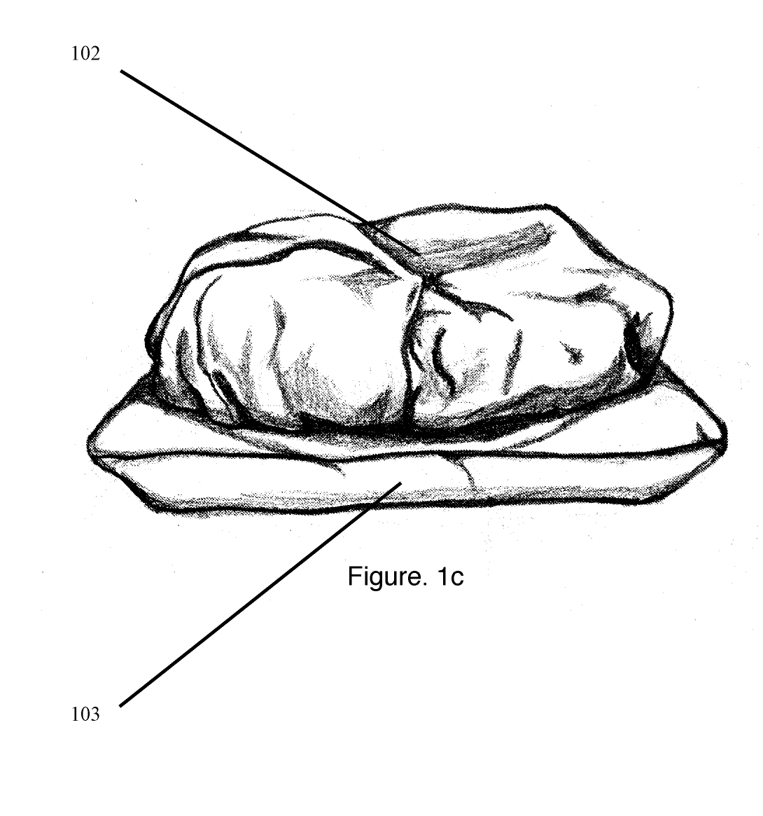

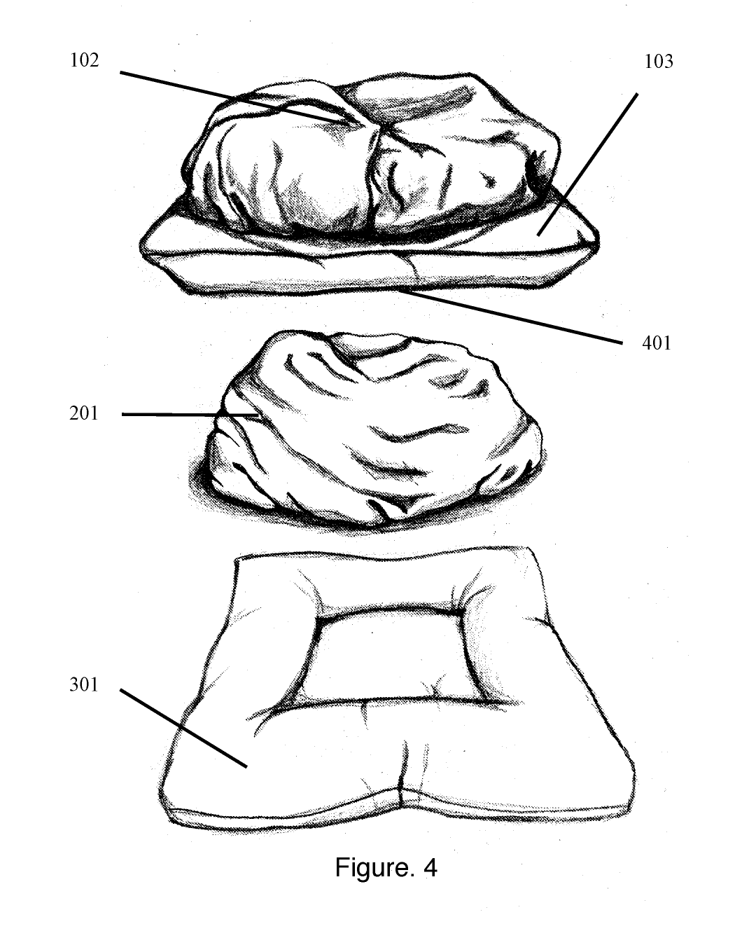

An overview of the cushion support product referring to FIG. 1 in this embodiment, a nestable pet bed, where an animal 101 could seek rest. Referring to FIG. 4, in an embodiment comprising an outer woven fabric cover which by creates an upper zone 102 and a lower zone 103. The zones within the outer woven fabric cover hold a top pouch insert 201 and a base insert 301. Each insert is individually encased and filled with material. In this embodiment where the outer woven cover is a single one piece cover an opening is included in the bottom of the cover 401. This opening 401 in the present embodiment closable by way of a zipper, however alternatives such as hook and loop may be used. The opening 401 may be left open by means of a finished fabric flapped edge.

Assemble the parts in order to make the whole product, (FIG. 4) first, the top pouch insert 201 is passed through the opening 401 and upward into the uppermost zone 102. In this embodiment the single piece outer cover has an opening between the upper zone 102 and lower zone 103 allowing the top pouch insert 201 to pass through. Second, pass the base insert 301 through the opening in the bottom of the outer cover 401 into the lower zone 103.

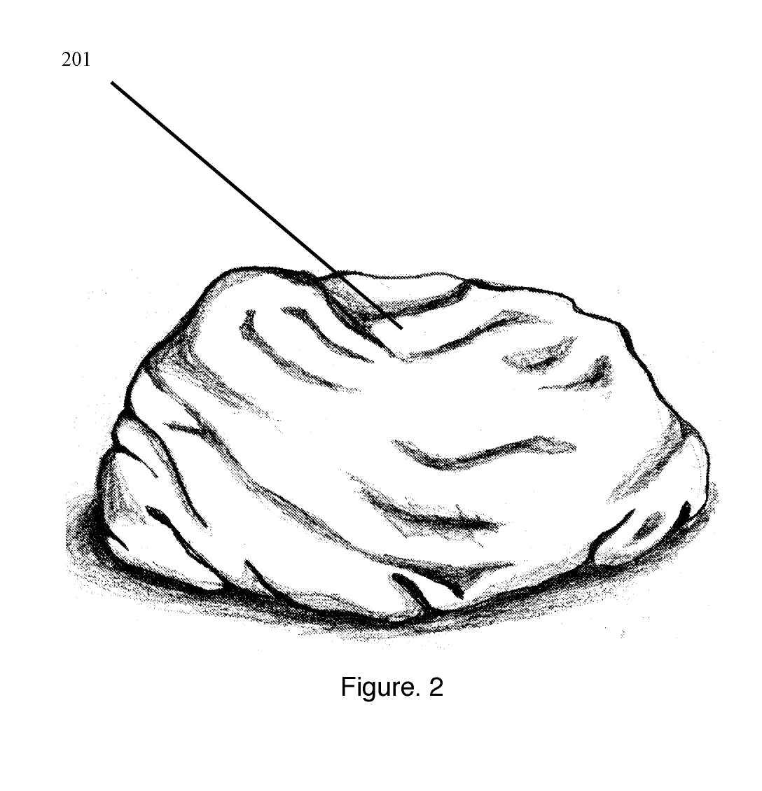

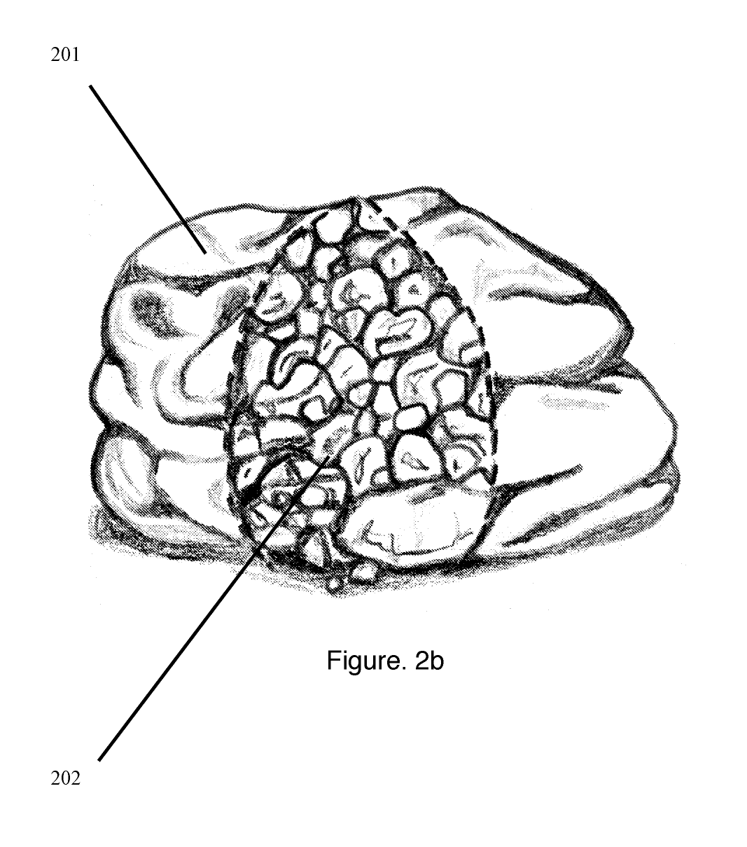

More specifically, in this embodiment, referring to FIGS. 2 and 2b where the material inside the the top pouch insert 201 is shredded polyurethane foam 202, approximately thumbnail sized chunks. However, any material that could be pieced into parts while remaining soft and resilient would work. The encasement of the top pouch insert 201 is woven fabric. The amount of material 202 filled into the top pouch insert 201 is subjective to a certain point and is also based on the size of the chunks. The goal being to loosely fill the encasement, allowing space for shifting of said material 202 to occur within the upper zone 102.

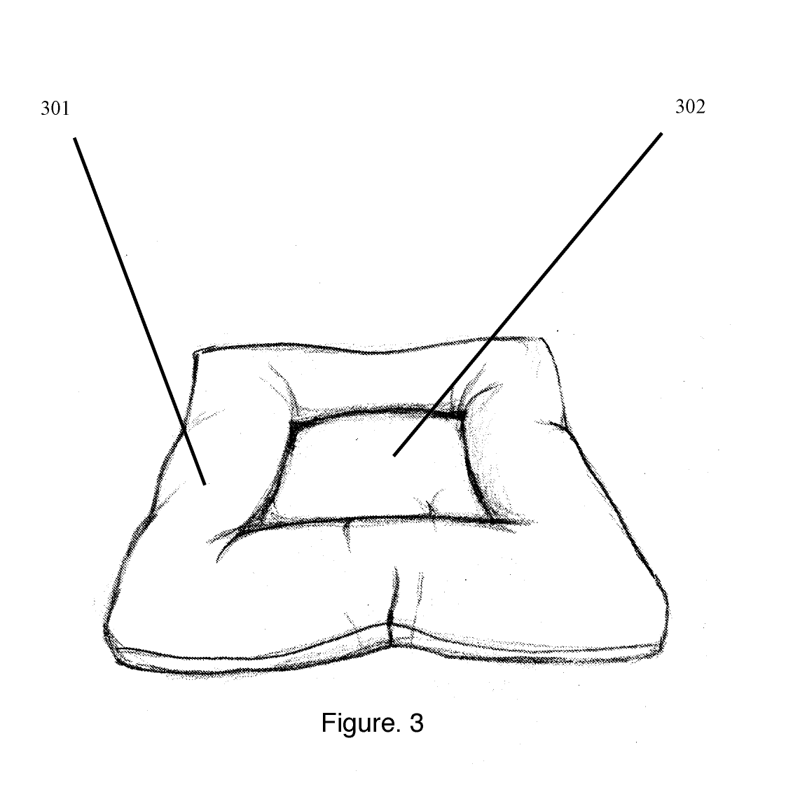

Referring to FIG. 3 The stuffing material of choice in the present embodiment is a siliconized polyester fiber for the base insert 301. However, any material that could be densely packed inside the encasement providing a uniform shape with resilience and firm support would work. The siliconized polyester fiber is densely packed into the base insert 301 keeping it a uniform shape. Additionally, in the present embodiment, a baffle is sewn in the center region of the base insert 301. The baffle technique is utilized to keep the densely packed fiber from shifting, helping the object remain a uniform shape 302, as governed by its woven fabric encasement 301. In this embodiment the size of the baffle 302 is determined in relation to the overall size of the base insert 301, such that the end result is a baffled center which, when stuffed, is not taller than the perimeter and ideally slightly lower than the perimeter.

In this embodiment, referring to FIG. 4, the woven fabric encasement of both the top pouch insert 201 and the base insert 301 are the same size and shape of the interior of the lower zone 103 of the outer cover. The base insert 301 in firmly packed with siliconized polyester fiber and therefore snuggly fits within the lower zone 103 of the outer cover. In comparison, the top pouch insert 201 is only partially filled with loose shredded polyurethane foam and therefore has a transformative shape within the upper zone 102 of the outer cover. Comparing FIG. 1 with 1b and 1c, it is evident that the upper zone 102, although ultimately constrained within the boundary of the outer cover, does not hold a uniform or consistent shape. In FIG. 1 it is most evident that the animal 101 resting on the nestable pet bed, is participating in a transformative effect of the upper zone 102. The upper zone 102 is a hollow, cradling the around the various body parts of the animal 101. The shifting of material in the top pouch insert 201 occurs with just the animal's weight on top of the nestable pet bed, as well as by way of nuzzling, pawing or circling by the animal 101. A depression formed in the upper zone 102 closely cradles the animal allowing a nesting experience with supple support while the lower zone 103 provides enhanced distributed orthopedic support. Therefore in this embodiment the choice of material utilized in the top pouch insert as well as the amount utilized are pertinent to the function. Where, in this embodiment, the function includes a nesting experience for the animal 101.

In this embodiment, referring to FIGS. 1 and 1c, the combination of the upper zone 102 and the lower zone 103 are essential and purposeful. While overall size can be varied with the same outcome, the vertical stacking of the zones is deliberate. The upper zone 102 is transformative and supple where it provides gentle support. The lower zone 103 provides firm and orthopedic support preventing the animal 101 from sinking to the hard surface below. The size of the zones 102 and 103, in relation to the animal must be large enough to accommodate the type and size of the animal. Considering FIGS. 1, 2, 2b and 3 The upper zone 102 is filled with a bulky chunked material 202 so that it is actually sharing the support of the animal, with the lower zone 103, more so than a blanket or a quilt may do. The distribution of the weight of the animal 101 is shared by both upper zone 102 and lower zone 103. The depression in the top pouch insert 201 closely cradles the animal 101 creating a nesting experience and gentle supple support while the base insert 301 provides enhanced distributed orthopedic support. The baffled area of the base insert 302 in this embodiment is lower than the perimeter allowing the animal 101 to naturally gravitate to the center of the nestable pet bed furthering the ability of the top pouch insert 201 to conform upward and around the animal 101.

In this embodiment, referring to FIGS. 1b and 1c with each use, the shape of the upper zone 102 of the nestable pet bed will change, within the constraint of the outer woven fabric cover while the shape of the lower zone 103 will remain consistent. The nestable pet bed can be shaken between uses to redistribute the material in the upper zone 102.

Alternative embodiments which have an upper and lower zone could be utilized. Common woven fabrics could be replaced with more advanced synthetic alternatives such as those made by polymerization, so long as the the vertically stacked zones could be accomplished and the supple nature of the upper zone was achieved. Such synthetic materials exist, and may be stronger and may stand up to animal chewing or damage, yet they may be proprietary and cost prohibitive.

Another alternative embodiment would be a multiple piece cover, where less sophisticated sewing would be necessary this may save in manufacturing expense. Although the product, from a consumer point of view, may appear more crude and less aesthetic. As an example, an independent cover for the lower zone combined with an independent cover for the upper zone. Because these covers are independent they may or may not utilize inserts. If no inserts were used, from the manufacturing point of view it is cheaper and faster to produce, yet from a consumer point of view is less advantageous because the outer cover will not be removable for washing. The independent upper zone and lower zones could for example utilized hook and loop attachments, or a system of snaps, to connect the vertically stacked zones.

Regardless of single or multiple covers, in addition to the invention as described, an alternative embodiment would add one or more bolster to the outer edge. The bolster could be fixed permanently or removable. Bolsters are a common addition to pet bedding. So while it may seem desirable, the open nature of the embodiment described presently allows the animal easy access to a bedding product, which due to its upper and lower zones is taller than average. It is important and advantageous to have the design where animals of a wide age group and physical ability could enter and exit without difficulty. Therefore adding bolsters would not be a sound choice. Similarly, due to the height of the two combined zones it would be a disadvantage to have more than two vertically stacked zones, although it would be possible from a manufacturing point of view.

The upper zone as mentioned, could alternatively be filled with, other chunked materials such as but not limited to, shredded memory foam/latex or even polystyrene beads. However, those options may pose toxic health risks to an animal if ingested. Not only was polyurethane foam preferred by the animals in our testing phase, because it is commonly used in household furniture it is considered safe for the animals. Polyester fiber for the lower zone is preferred because is is commonly utilized in pet toys and bedding and is thus far not proved toxic to animals. Additionally, the lower zone does not inherently need to be firmly packed with material. The lower zone could be filled with a variety of polyester fibers including but not limited to those made from recycled bottles. The lower zone could also for instance be filled with materials such as but not limited to, chunked material or a solid piece of memory foam/polyurethane foam cut to fit. It is however, preferred that the lower zone be firm and supportive so using chunked material is not as desirable in the lower zone. Solid foam cut to size and shape requires additional skill and tools and may increase production costs.

What should be most expressly understood is the cushion support product, while primarily intended for use by domestic animals, has alternative applications as discovered in the testing phase and therefore other user groups would not limit the invention. The above aforementioned alternative embodiments, while possible do not operate most efficiently or effectively, but they may be satisfactory. While it is possible to manipulate the invention, by way of alternating the type of fabric, or by changing a single cover to a multiple piece cover or by alternating the material compounds within the cover, or by forgoing the encased inserts, or by forgoing or alternating the use of zippers at the opening, or by adding more than 2 zones, or by altering the size or shape of the zones; therefore it is important, that claims be regarded as including such equivalent constructions insofar as they do not depart from the spirit and scope of the present invention.

What is claimed is:

1. A cushion support product comprising:
a. a cushion body with a cover defining its overall shape,
b. said cover also defining at least two distinct zones,
c. said zones are vertically stacked encased within said cover,
d. the uppermost zone is filled, with resilient bulky soft pliable material, that is pieced into parts,
e. said uppermost zone is loosely filled affording space allowing shifting of the material within the zone,
f. the lower zones, single or multiple, are filled with a resilient material.

2. The cushion support product of claim 1 wherein the cover is multiple pieces.

3. The cushion support product of claim 1 wherein there are one or more inserts within said zones, housing said materials.

4. The cushion support product of claim 1 wherein said cover is removable.

5. The cushion support product of claim 1 wherein there is one or more fixed or removable bolster added.

6. The cushion support product of claim 1 wherein said uppermost zoned is filled with polystyrene beads.

7. The cushion support product of claim 1 wherein any of the single or multiple lower zones are filled with solid foam cut to size and shape of said cover.

8. The cushion support product of claim 1 wherein any product used in said cover or utilized as the material for filling is recycled from pre or post consumer waste.

9. The cushion support product of claim 1 wherein any component is made from water resistant, waterproof or chew resistant goods.

10. A cushion support product comprising:
a. a cushion body means, with at least two distinct vertically stacked zones within a cover defining its shape, providing comfort and a place of rest,
b. the lower zone of said cushion body means, single or multiple, filled with a resilient material, provides evenly dispersed support for the occupant,
c. the uppermost zone of said cushion body means is loosely filled with resilient bulky soft pliable material, that is pieced into parts allowing shifting of the material within said zone, providing a nesting experience for said occupant.

11. The cushion support product of claim 10 wherein the cover is multiple pieces.

12. The cushion support product of claim 10 wherein there are one or more inserts within said zones, housing said materials.

13. The cushion support product of claim 10 wherein said cover is removable.

14. The cushion support product of claim 10 wherein there is one or more fixed or removable bolster added.

15. The cushion support product of claim 10 wherein said uppermost zoned is filled with polystyrene beads.

16. The cushion support product of claim 10 wherein any of the single or multiple lower zones are filled with solid foam cut to size and shape of said cover.

17. The cushion support product of claim 10 wherein any product used in said cover or utilized as the material for filling is recycled from pre or post consumer waste.

18. The cushion support product of claim 10 wherein any component is made from water resistant, waterproof or chew resistant goods.
